(19) United States
(12) Patent Application Publication
(10) Pub. No.: US 2022/0270063 A1
(43) Pub. Date: Aug. 25, 2022

(54) PRODUCE AND BULK GOOD MANAGEMENT WITHIN AN AUTOMATED SHOPPING ENVIRONMENT

(71) Applicant: Grabango Co., Berkeley, CA (US)

(72) Inventors: William Glaser, Berkeley, CA (US); Brian Van Osdol, Piedmont, CA (US)

(21) Appl. No.: 17/564,084

(22) Filed: Dec. 28, 2021

Related U.S. Application Data
(63) Continuation of application No. 16/398,098, filed on Apr. 29, 2019, now abandoned.
(60) Provisional application No. 62/663,818, filed on Apr. 27, 2018.

(51) Int. Cl. G06Q 20/20

(52) U.S. Cl. CPC G06Q 20/201; G06Q 20/209; G06Q 20/208; G06Q 20/202

(57) ABSTRACT

A system and method for produce and bulk good monitoring that includes: at a computer vision monitoring system, collecting image data; detecting selection of a set of items by a first user through computer vision, the items having been displayed in an environment; applying computer vision to the image data and detecting an item identity of the set of items; collecting weight information from a scale when the item is present at the scale; and generating an item price factoring in weight information and the item identity.

### CROSS-REFERENCE TO RELATED APPLICATIONS

This application is a Continuation Application of U.S. patent application Ser. No. 16/398,098, filed on 29 Apr. 2019, which claims the benefit of U.S. Provisional Application No. 62/663,818, filed on 27 Apr. 2018, both of which are incorporated in their entirety by this reference.

### TECHNICAL FIELD

This invention relates generally to the field of computer vision applications, and more specifically to a new and useful system and method for produce and bulk good monitoring within an automated shopping environment.

### BACKGROUND

New and emerging checkout experiences that use computer vision and the application of sensor fusion have recently been introduced. Many of the current implementations however are restrained to simple use-cases. For example, demos of automatic checkout are mostly limited to prepackaged items with clear packaging or labeling. Such implementations may have applications in some shopping environments. However, existing implementations are not sufficient for use within normal shopping environments such as traditional grocery stores or markets. One problem with existing systems is that they are not able to work for complex items like produce or bulk goods. Thus, there is a need in the computer vision application field to create a new and useful system and method for produce and bulk good management within an automated shopping environment. This invention provides such a new and useful system and method. Thus, there is a need in the computer vision application field to create a new and useful system and method for produce and bulk good monitoring within an automated shopping environment. This invention provides such a new and useful system and method.

### BRIEF DESCRIPTION OF THE FIGURES

FIGS. 1 and 2 are schematic representations of a system of a preferred embodiment;

FIG. 3 is a flowchart representation of a first method;

FIG. 4 is a flowchart representation of a method collecting weight by an integrated scale;

FIG. 5 is a flowchart representation of a method collecting weight through volumetric estimation;

FIGS. 6-8 are variations of combining collecting weight by an integrated scale and volumetric estimation;

FIGS. 9A and 9B are variations of systematic weight collection systems in use with the system;

FIGS. 10A and 10B are variations of collecting weight information from a scale; and

FIGS. 11A-11H are schematic representations of variations of volumetric interpretation and weight tracking.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for managing produce or bulk goods within an automatic shopping environment functions to dynamically extract produce and bulk good metrics for accurate item accounting and handling. The system and method is preferably applied to monitoring of produce like fruits and vegetables, which may be sold, by weight, bunch, and/or item. In particular, the system and method is used to enable weight-based pricing of such items where item selection is detected and tracked in response to customer selection of an item. The system and method may similarly be applied to other bulk goods like dried goods or other items where the quantity and properties like volume or weight may be considered in determining checkout processing (e.g., to calculate price).

The system and method are preferably applied to automatic or semi-automatic checkout experiences. Herein, automatic checkout is primarily characterized by a system or method that generates or maintains a virtual cart (i.e., a checkout list) during the shopping experience with the objective of knowing the possessed or selected items for billing a customer. The checkout process can occur when a customer is in the process of leaving a store. The checkout process could alternatively occur when any suitable condition for completing a checkout process is satisfied such as when a customer selects a checkout option within an application.

A virtual cart may be maintained and tracked during a shopping experience. In performing an automatic checkout process, the system and method can automatically charge an account of a customer for the total of a shopping cart and/or alternatively automatically present the total transaction for customer completion. Actual execution of a transaction may occur during or after the checkout process in the store. For example, a credit card may be billed after the customer leaves the store. Alternatively, single item or small batch transactions could be executed during the shopping experience. For example, automatic checkout transactions may occur for each item selection event. Checkout transactions may be processed by a checkout processing system through a stored payment mechanism, through an application, through a conventional PoS system, or in any suitable manner.

One variation of a fully automated checkout process may enable customers to select items for purchase (including produce and/or bulk goods) and then leave the store. The automated checkout system and method could automatically bill a customer for selected items in response to a customer leaving the shopping environment. The checkout list can be compiled using computer vision and/or additional monitoring systems. In a semi-automated checkout experience variation, a checkout list or virtual cart may be generated in part or whole for a customer. The act of completing a transaction may involve additional systems. For example, the virtual cart can be synchronized with a point of sale (POS) system manned by a worker so that at least a subset of items can be automatically entered into the POS system thereby alleviating manual entry of the items.

While the system and method for managing produce and bulk goods is preferably applied to accounting for customer selection of a subset of items. Alternatively, the system and method may be used for other suitable applications such as for tracking produce usage in a restaurant, farm, food handling facility, and the like.

Managing produce and bulk goods preferably involves one or more processes relating to operational logistic involving the items. In a preferred variation, managing produce and bulk goods can include pricing and accounting for produce and bulk goods when generating a checkout list. Accordingly, the system and method can serve as a reliable technological solution to detecting the items selected, physical properties of the items that determine pricing, and then associating a resulting line-item record with a user, that can be used for executing a purchase transaction that is for at least that line item record.

Alternative variations, may track and record items and their corresponding physical properties along with handling of those items by a worker or machine. For example, a grocery store may use the system to track the quality of produce and value while workers stock the goods and customers select goods. Herein, the system and method are primarily described as it applies to item pricing and forms of automatic checkout, but one skilled in the art can appreciate that the system and method may alternatively be applied to other use cases.

The system and method can have applications in a wide variety of environments. In one variation, the automatic checkout processing of the system and method can be used within an open environment such as a shopping area or sales floor where customers interact with inventory and purchasable goods. A customer may interact with inventory in a variety of manners, which may involve product inspection, product displacement, adding items to carts or bags, and/or other interactions. The system and method can be used within a store environment such as a grocery store, convenience stores, micro-commerce & unstaffed stores, bulk-item stores, super stores, retail stores, big box store, electronics store, bookstore, convenience store, drugstore, pharmacy, warehouses, malls, markets, shoe store, clothing store, and/or any suitable type of shopping environment.

As one potential benefit, the system and method can enable traditional grocery operations within a store while enabling new checkout experiences like automatic checkout. For example, a grocery store could launch an automatic checkout feature within a store without changing how they charge for fruits and produce. Customers not using the automatic checkout feature may notice no change within the store. Customers using the automatic checkout feature can continue to shop without significantly altering shopping behavior.

As another related potential benefit, the system and method alleviate dependence on pre-packaging of produce to make it suitable for computer vision monitoring. This would make selling produce with sensor-based monitoring more operationally efficient and less wasteful from a packaging standpoint.

As another potential benefit, the system and method can offer two or more modes of accounting for produce. The purchase of produce could be managed through a dynamic and reactive system where a first approach to accounting is used initially, and a second approach of accounting may be enabled to override the first approach. For example, a customer may be able to select an apple. As a first approach, computer vision-based volume/weight predictive modeling can be used to initially generate a predicted priced-by-weight item price for the apple. The pricing for this first approach may be set to account for some error and/or item-value variation. As a second approach, if the item is detected to be weighed at a scale, (after selection or possibly before) revised pricing based on measured weight may be used for the apple. The first approach may be desired by customers that value convenience. The second approach may be enabled by customers that want to enable more price conscious item pricing in exchange for taking the time to measure the weight.

As a related and more general benefit, the system and method may enable a whole field of alternative technology business systems and operations. Stores could change how they operate and target better efficiency and quality in their services and goods. For example, the system and method may enable alternative pricing beyond weight-based pricing such as pricing by quality and state of produce and goods. For example, the ripeness of an avocado, for example, along with its size, and/or detection of or lack of defects could be systematically assessed and used to generate an item-specific price. Customers can therefore make buying decisions based on, cost, quality, and their personal desires/preferences. Additionally or alternatively, stores can operate differently with supplies of produce and goods, where they can be paid based on true, systematic evaluation of the quality of their goods not only at the time of delivery but in their performance and during their shelf life.

As another potential benefit, the system and method can enable a variety of enhancements to a customer's user experience. The remote sensing and accounting of produce and bulk good information can be used to create new user experiences. As one variation, the system and method could facilitate, immediate communication of produce information in response to item selection or inspection. For example, when a customer picks up a group of apples, the system and method could determine weight and price information and then relay that information directly to a personal computing device of the customer such as a smart phone, headphones, smart glasses, smart watch, and/or the like. In one implementation, the resulting item price can be audibly announced through a connected headset.

As another potential benefit, the system and method can enhance store scales in a variety of ways. Traditional scales without any digital communication means can become integrated into a monitoring system through computer vision. In this way a store can be alleviated from introducing new and expensive scales. At the same time, new connected scales could become further enhanced. For example, the system and method could facilitate automatically communicating with a scale such that monitoring system informs the scale as to the identity of the product being weighed. Other types of enhancements may additionally be enabled.

As another potential benefit, the system and method can build a deeper understanding of produce value beyond weight, which may enable item pricing by color, shape, volume, placement in a collection (e.g., at the bottom of a pile or on top), and/or other properties. Analytic systems can be developed wherein produce sourcing can be driven in part by produce quality evaluation which may consider produce item weight, color, shape, and/or other produce properties.

### 2. System

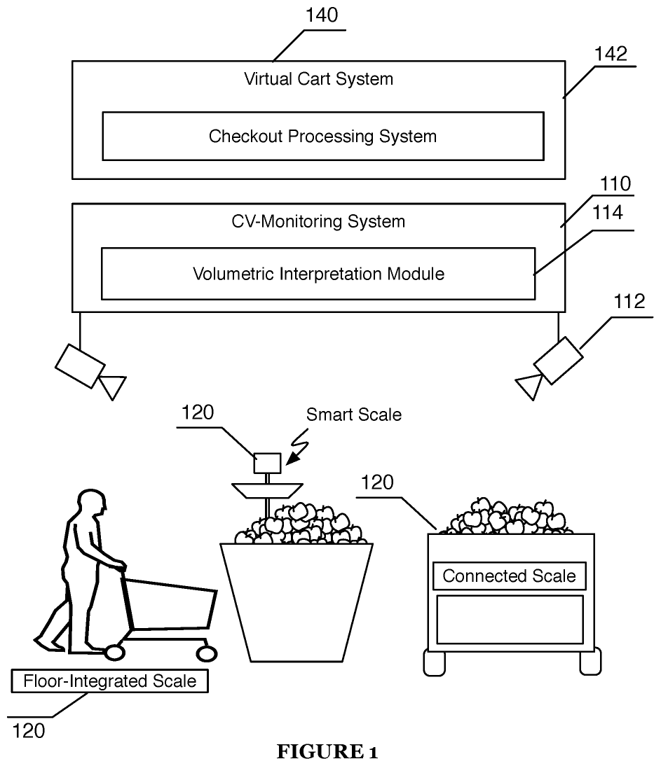

As shown in FIG. 1, a system for managing produce or bulk goods within an automatic shopping environment can preferably generate a weight-based estimate of items like produce in a shopping environment and appropriately account for customer selection of those items. The system preferably includes a computer vision (CV) monitoring system 110 configured for collecting image data, detecting selection by a user of a set of items displayed in the shopping environment, and detecting an item identity of the set of items. The system may include a volumetric estimation module 114 as part of the CV monitoring system 110 and/or a scale 120 used by the system in collecting weight information of a set of items. A virtual cart system 140 in coordination as part of a checkout processing system 142 may track a virtual cart/checkout list of a user and updated with by-weight item records generated by the system.

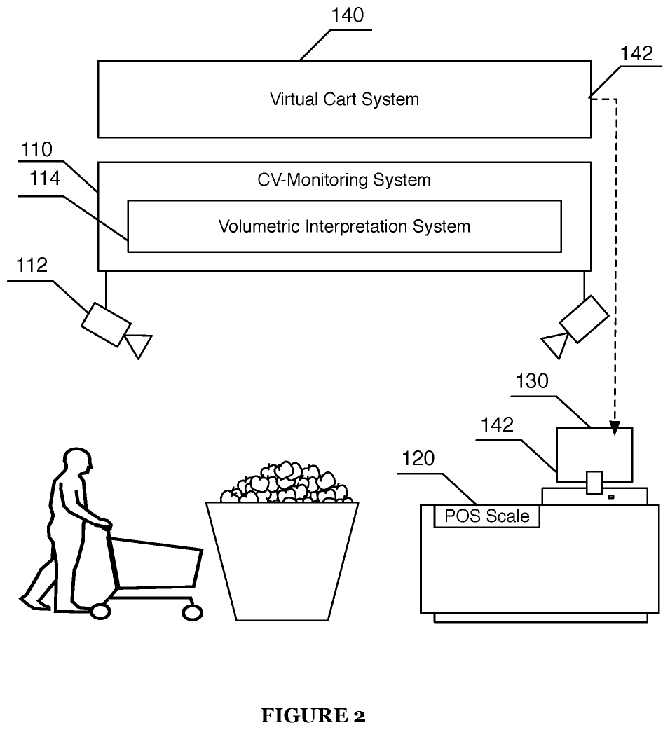

In one variation, the system may be integrated with or interface a POS system as shown in FIG. 2 to facilitate automated entry of information related to weight, item identification, and/or item price by weight. The system may include a checkout application 130 of a POS system as shown in FIG. 2.

A CV monitoring system 110 of a preferred embodiment functions to transform image data collected within the environment into observations relating in some way to subjects in the environment. Preferably, the CV monitoring system no is used for detecting items (e.g., products), monitoring users, tracking user-item interactions, and/or making other conclusions based on image and/or sensor data. The CV monitoring system 110 will preferably include various computing elements used in processing image data collected by an imaging system 112. In particular, the CV monitoring system 110 will preferably include an imaging system 112 and a set of modeling processes and/or other processes to facilitate analysis of user actions, item state, volumetric interpretation, and/or other properties of the environment.

As mentioned, the CV monitoring system 110 in one exemplary implementation is used to track a virtual cart of subjects for offering automated checkout. In some variations the CV monitoring system 110 is the primary sensing solution for generating and managing the virtual cart for customers. However, alternative automated checkout systems may alternatively be used such as RFID tag-based tracking, sensor fusion, user-facilitated entry of items into an app, smart carts/baskets, smart shelves, and the like. The system may be used to supplement the automated checkout system, a subsystem of the automated system, and/or a configured mode of the automated checkout system.

The CV monitoring system 110 preferably provides specific functionality that may be varied and customized for a variety of applications. In addition to item identification, the CV monitoring system 110 may additionally facilitate operations related to person identification, virtual cart generation, item interaction tracking, store mapping, and/or other CV-based observations. Preferably, the CV monitoring system 110 can at least partially provide: person detection; person identification; person tracking; object detection; object classification; object tracking; gesture, event, or interaction detection; detection of a set of customer-item interactions, and/or forms of information.

In one preferred embodiment, the system can use a CV monitoring system 110 and processing system such as the one described in the published US Patent Application 2017/0323376 filed on May 9, 2017, which is hereby incorporated in its entirety by this reference. The CV monitoring system 110 will preferably include various computing elements used in processing image data collected by an imaging system 112.

The imaging system 112 functions to collect image data within the environment. The imaging system 112 preferably includes a set of image capture devices. The imaging system 112 might collect some combination of visual, infrared, depth-based, lidar, radar, sonar, and/or other types of image data. The imaging system 112 is preferably positioned at a range of distinct vantage points. However, in one variation, the imaging system 112 may include only a single image capture device. In one example, a small environment may only require a single camera to monitor a shelf of purchasable items. The image data is preferably video but can alternatively be a set of periodic static images. In one implementation, the imaging system 112 may collect image data from existing surveillance or video systems. The image capture devices may be permanently situated in fixed locations. Alternatively, some or all may be moved, panned, zoomed, or carried throughout the facility in order to acquire more varied perspective views. In one variation, a subset of imaging devices can be mobile cameras (e.g., wearable cameras or cameras of personal computing devices). For example, in one implementation, the system could operate partially or entirely using personal imaging devices worn by users in the environment (e.g., workers or customers).

The imaging system 112 preferably includes a set of static image capture devices mounted with an aerial view from the ceiling or overhead. The aerial view imaging devices preferably provide image data that observes at least the users in locations where they would interact with items. Preferably, the image data includes images of the items and users (e.g., customers or workers). While the system (and method) is described herein as they would be used to perform CV as it relates to a particular item and/or user, the system and method can preferably perform such functionality in parallel across multiple users and multiple locations in the environment. Therefore, the image data may collect image data that captures multiple items with simultaneous overlapping events. The imaging system 112 is preferably installed such that the image data covers the area of interest within the environment.

In one variation, imaging devices may be specifically setup for monitoring a particular product or group of products. For example, one or more image capture devices could be specifically arranged and oriented for monitoring stored produce or bulk good bins. An image capture device may additionally or alternatively be oriented to view a scale.

Herein, ubiquitous monitoring (or more specifically ubiquitous video monitoring) characterizes pervasive sensor monitoring across regions of interest in an environment. Ubiquitous monitoring will generally have a large coverage area that is preferably substantially continuous across the monitored portion of the environment. However, discontinuities of a region may be supported. Additionally, monitoring may monitor with a substantially uniform data resolution or at least with a resolution above a set threshold. In some variations, a CV monitoring system 110 may have an imaging system 112 with only partial coverage within the environment.

A CV-based processing engine and data pipeline preferably manages the collected image data and facilitates processing of the image data to establish various conclusions. The various CV-based processing modules are preferably used in generating user-item interaction events, a recorded history of user actions and behavior, and/or collecting other information within the environment. The data processing engine can reside local to the imaging system 112 or capture devices and/or an environment. The data processing engine may alternatively operate remotely in part or whole in a cloud-based computing platform.

User-item interaction processing modules function to detect or classify scenarios of users interacting with an item. The user is preferably a customer in a store environment but may alternatively be a worker or any suitable person. User-item interaction processing modules may be configured to detect particular interactions through other processing modules. For example, tracking the relative position of a user and item can be used to trigger events when a user is in proximity to an item but then starts to move away. Specialized user-item interaction processing modules may classify particular interactions such as detecting item grabbing or detecting item placement in a cart. User-item interaction detection may be used as one potential trigger for an item detection module.

Preferably, there are multiple customer-item interaction processing modules that enable conditioning on scenarios such as customer passing an item, viewing an item, picking up an item, comparing the item to at least a second item, selecting an item for purchase (e.g., putting in cart or bag), and the like.

A person detection and/or tracking module functions to detect people and track them through the environment.

A person identification module can be a similar module that may be used to uniquely identify a person. This can use biometric identification. Alternatively, the person identification module may use Bluetooth beaconing, computing device signature detection, computing device location tracking, and/or other techniques to facilitate the identification of a person. Identifying a person preferably enable customer history, settings, and preferences to be associated with a person. A person identification module may additionally be used in detecting an associated user record or account. In the case where a user record or account is associated or otherwise linked with an application instance or a communication endpoint (e.g., a messaging username or a phone number), then the system could communicate with the user through a personal communication channel (e.g., within an app or through text messages).

A gesture, event, or interaction detection modules function to detect various scenarios involving a customer. For example, physical selection of one or more items could be detected through such a detection module.

The item detection module of a preferred embodiment, functions to detect and apply an identifier to an object. The item detection module preferably performs a combination of object detection, segmentation, classification, and/or identification. This is preferably used in identifying products or items displayed in a store. Preferably, a product can be classified and associated with a product SKU (stock keeping unit) or PLU (price look up) identifier. In some cases, a product may be classified as a general type of product. For example, apples may be labeled as apple without specifically identifying the apple type SKU of that particular apple. An object tracking module could similarly be used to track items through the store. Tracking of items may be used in determining item interactions of a user in the environment.

The system may include a number of subsystems that provide higher-level analysis of the image data and/or provide other environmental information. In some preferred implementations, the system may include a real-time inventory system and/or a real-time virtual cart system 140.

The real-time inventory system functions to detect or establish the location of inventory/products in the environment. The item detection module in some variations may be integrated into a real-time inventory system. Information on item location is preferably usable for location aware volumetric estimation of items. For example, a generated map or pre-configured map of an environment may be used to determine how to interpret volume of a selected item.

The inventory system may include tracked item metrics of directly sensed or measured item properties. More specifically, measured weight or volumetric data for a specific item or set of items can be recorded and tracked. Weight may be sensed by a scale or predicted from volumetric approximation or other approximation approaches. The items are preferably tracked through computer vision such that item associated properties such as weight may be maintained as the item is moved and interacted with.

The inventory system may include an inventory property database wherein weight and/or volume may be stored. Additional item related properties may additionally be tracked such as color characterization, inventory source, date of stocking, history of location/placement, and the like.

The real-time virtual cart system 140 functions to model the items currently selected for purchase by a customer. The virtual cart system 140 may enable forms of automated checkout such as automatic self-checkout (e.g., functionality enabling a user to select items and walk out) or accelerated checkout (e.g., selected items can be automatically prepopulated in a POS system for faster checkout). Product transactions could even be reduced to per-item transactions (e.g., purchases or returns based on the selection or de-selection of an item for purchase). A virtual cart or other suitable accounting for customer related actions is preferably maintained for the duration of a customer's shopping session. A virtual cart may not be maintained for each customer. For example, a virtual cart is preferably only initiated and recorded after an initial item is selected. Once a virtual cart is established for a user. The user is preferably tracked, and the virtual cart is acted on during a checkout process. The checkout process may be initiated when detecting the user leave the store or a particular region. The checkout process may alternatively be initiated when interacting with a checkout kiosk or worker-stationed POS system. A subset of the items in a virtual cart may be items like produce or bulk goods with by-weight or property-based pricing.

The CV monitoring system 110 may additionally or alternatively include human-in-the-loop (HL) monitoring which functions to use human interpretation and processing of at least a portion of collected sensor data. Preferably, HL monitoring uses one or more workers to facilitate review and processing of collected image data. The image data could be partially processed and selectively presented to human processors for efficient processing and tracking/generation of a virtual cart for users in the environment.

The virtual cart system 140 preferably includes or interfaces with a checkout processing system 142. The checkout processing system 142 functions to complete a transaction in response to a generated virtual cart. As discussed, the checkout processing system 142 is preferably configured to accept virtual cart items that are at least partially dependent on the volumetric estimations. For example, the checkout processing system 142 can support charging for produce by weight. Other items may be priced by size, shape, colorization, and/or any suitable combination of physical properties.

Additionally, the system can include a checkout application 130 which could be a web or native application, cashier application, a POS user interface, self-checkout kiosk interface, and/or other suitable user interaction interface used to manage a checkout processing system 142. The checkout application 130 can communicate with the computer vision monitoring system in appropriately synchronizing information to facilitate a checkout process.

In one variation, the checkout application 130 can be a system that acts as a recipient of resulting item price information. For example, if the item identity (and thereby by-weight pricing) and a measured or estimated value for weight is obtained, a corresponding line item can be communicated to the checkout application 130 to be transferred to a checkout system. Alternatively, the line item may be directly communicated to the checkout system.

In another variation, the checkout application 130 includes or interfaces with a digital scale and is used to collect weight information, which can be paired with CV-based item identification for a resulting item line item. In this variation, the customer may be expected to or optionally decide to supply by-weight items to a worker for weight entry. The CV monitoring system 110 preferably detects and tracks the by-weight items when present on the digital scale such that the appropriate weight information can be recorded for the correct items. The product identifiers of the items may be communicated to the checkout application 130 from the CV monitoring system 110 while the weight information is communicated from the scale. A result can be communicated to the checkout processing system 142 (e.g., the POS system).

In some variations, the system can include or interface with one or more scales. The scales may can be network-connected scales or communication de-coupled scales. The system will generally include a plurality of scales, and the CV system is preferably used to track, which items correspond to measurements of which scales.

In variations including integrated scales, the system may collect weight to directly detect item weight or to infer item weight. This may be done with or without volumetric estimation. In some variations, a weight measurement could be used in combination with a volumetric estimation to arrive at a refined volume and/or weight estimation for an item or items.

In some cases, collecting at least some weight information of items can be used to enhance volumetric estimation and/or weight prediction of other instances of use. Active sensing could be particularly useful where the weight of a type of item could change depending on the source, time of year, season. For example, apples weight and density could change based on the amount of water content in the apples, and this could change over the course of a season and dependent on the harvest conditions for a particular harvest of apples.

A network-connected scale (or “smart” scale as used herein) is a scale with some communication system to transmit and/or receive data. A smart scale in one variation will transmit weight data to a processing system such as the CV monitoring system 110. The CV monitoring system 110 can preferably visually monitor and identify the products present at the smart scale during the time associated with the weight data. A smart scale in another variation will receive product identifier information automatically based on the CV monitoring system no identifying items present at the smart scale. The product identifier information in one variation may be used in generating a product label combining the product identifier information and the measured weight information and printing the product label.

A communication de-coupled scale is a scale that has no active communication integration with the system. In other words, a communication de-coupled scale lacks an established or used channel for data communication. In some instances, a communication integration may exist but is not used. Communication de-coupled scales would include traditional scales such as analog scales or regular digital scales. For integration with a communication de-coupled scale, the imaging system 112 will have at least one image capture device oriented to capture the visual output of the scale. In some instances, the visual output may be a dial or a digital display that displays the information as a measurement or a character-based indication of the weight. In some variations, the communication de-coupled scale could be a digital scale with a machine-readable visual display. For example, the weight information may be displayed through a machine-readable code like a QR code.

The system may include additional environmental augmented infrastructure that functions to facilitate volumetric estimation and/or weight information. The augmented infrastructure can include various types of scales configured for collecting weight measurements at various times which can be associated with an item or collection of items. In these variations, the scales are integrated into features of the environment for more seamless and possibly transparent measurement of weight information.

Augmented infrastructure can include substantially permanent equipment in the environment like shelves, product display stands, floors, and the like. Some preferred variations can include storage-integrated scales, floor-integrated scales, and stocking cart integrated scales. The augmented infrastructure is preferably network connected. However, communication de-coupled scales may alternatively be used.

A storage-integrated scale functions to measure weight of items or changes in weight from storage infrastructure. Storage integrated scales could be a bin, shelf, display case, or other suitable type of display units used to present items for purchase in a shopping environment. Produce in particular may be stored with a bin storage-integrated scale (a “smart bin” where large groups of produce items are displayed in the smart bin. A smart bin may be used to display a single type of item. But in some variations, two or more types of items can be displayed. The CV monitoring system 110 can preferably be used to interpret weight value changes as they should map to items. For example, a weight change detected for a bin storing apples and bananas will be assigned to the weight of apples if the CV monitoring system 110 detects that at the time of the weight change a customer was selecting an apple. A smart bin will preferably include at least one load cell or weight sensing mechanism. In another variation, the smart bin may include an array of weight sensing mechanisms.

A floor-integrated scale functions to measure changes from the floor. A floor-integrated scale may be useful in that a produce section could be built with the floor-integrated scale and then any suitable type of traditional storage systems may be used. A floor-integrated scale is preferably positioned in close proximity to items subject to volumetric interpretation (e.g., adjacent to the display unit). The floor-integrated scale could detect changes in weight of a customer and/or storage infrastructure after an item is selected. The floor integrated scale could additionally or alternatively be used to monitor the weight of items as a worker transfers them to a shelf. The shelving units could similarly have integrated load cells or other weight sensing mechanisms. An array of weight sensors could additionally identify weight changes based on location, which could be correlated with CV modeling of items and their location.

Augmented infrastructure may also include augmented equipment like smart stocking carts (used by workers) with an integrated scale. A smart stocking cart could measure the decrease in weight while items are transferred from the cart to a shelf. The added weight to a shelf can then be used to model expected weight of selected items at that location.

The system may additionally include a feedback system, which in some variations may be used to prompt actions by workers and/or customers when interacting with produce. The feedback system could output feedback and/or receive user input. Output feedback could be visual or audio feedback. In one example, system may trigger a “item weight check” alert for a user if, for example, weight estimation has a low confidence. A connected scale may include such a feedback system. The connected scale could additionally report the measured weight of items weighed in it.

The system may additionally include one or more volumetric estimation modules 114 that can execute in cooperation between the CV monitoring system 110 and other system elements such as a connected scale. Volumetric estimation modules 114 may include processing modules for item-collection volumetric detection, individual item volumetric detection, predictive volume estimation, and/or other processing modules such as the processes described below. The volumetric estimation module 114 functions to estimate volume. The volume can be used in combination with an item density database to generate predicted weights from predicted volumes. The volumetric estimation module 114 preferably included machine configuration to perform the various volumetric estimation processes described herein such as generating a volume estimate of a collection of items, generating a volume estimate of an individual item, predictively modeling the volume of an item from a limited visual view of the item.

### 3. Method

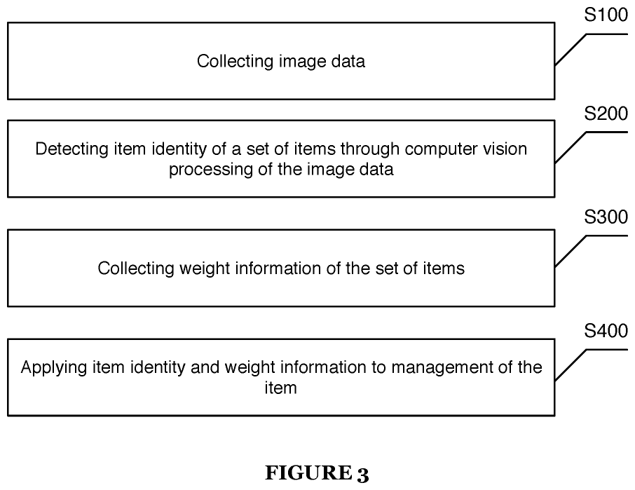

As shown in FIG. 3, a method for managing produce or bulk goods in an automated shopping environment can include collecting image data S100, detecting item identity of a set of items through computer vision processing of the image data S200, collecting weight information of the set of items S300, and applying item identity and weight information to management of the item S400. The method preferably functions to track and establish an association of the weight information to a specific item or set of items where the items are preferably products in a store. The method preferably operates by obtaining direct or indirect weight measurements and/or volumetric interpretation to predict weight and integrating such processes with CV-enabled tracking and association of items, users, and their interactions.

Applying item identity and weight information to management of the item S400 preferably includes generating an item price estimate. For example, a user selecting one or more items of produce will result in the generation of a price based on a price-per-weight pricing scheme. As discussed, the method can be implemented within an automatic shopping environment (e.g., store supporting automatic checkout) or a semi-automated shopping environment (e.g., accelerated checkout at a checkout station). However, as described herein, weight, volume, and/or other item property metrics associated with a CV identified (and optionally tracked) item may have utility to a variety of processes and operations.

Herein, the method is primarily described as it would be applied in a single instance for a single collection of items. The method is preferably parallelizable such that multiple user interactions with items can be monitored. For example, multiple users may simultaneously select items from a collection of fruit, and an appropriate item price estimate can be generated based on the items specifically selected by each customer.

In one exemplary instance of use the method can include collecting image data S100, detecting selection of a set of items from storage by a first user through computer vision S210; applying computer vision to the image data and detecting an item identity of the set of items S220; collecting weight information of the first set of items S300, and generating an item price factoring in weight information and the item identity of the first set of items for a checkout list of the first user S410 and then, later or at least partially in parallel, detecting selection of a second set of items from storage by a second user through computer vision S210; applying computer vision to the image data and detecting an item identity of the set of items S220; collecting weight information of the second set of items S300, and generating an item price factoring in weight information and the item identity of the second set of items for a checkout list of the second user S410. Similarly, one user (where the first and second user are the same user in the example above) may have the method repeated for multiple produce or bulk good items selected by the user.

Additionally, the method is described for a single item collection. The method may additionally be extended to multiple item collections. In a multiple collection variation, individualized item modeling parameters may be managed for each type of item. In other words, the method can preferably be used on a variety of types of produce items in a store, preferably all items benefiting from by-weight management.

In a preferred implementation, the method is applied in an environment with multiple types of items and with multiple users interacting with the items such as in the produce section of a supermarket.

The method may additionally include detecting the type of item and selectively applying appropriate volumetric modeling and/or CV-based identification. The detection of an item type may be based on pre-configured item location. For example, a map of item organization within an environment may be configured such that collected image data can be associated with appropriate item types. In another variation, item collections may be algorithmically identified through computer vision or other suitable techniques.

The method is preferably implemented by a system substantially similar to the one described here, and the variations of the system may be used in combination with the method. However, the method may alternatively be implemented by a different system.

The method can be an implementation of one or more varied approaches to extracting a weight metric and mapping the weight metric to a computer vision identified product an item and then using computer vision to associate the metric to that item. The associated weight metric is preferably persistently associated with the item and transferrable to other CV detected interactions with that item (either previously or at a later time). In other words, the method can preferably establish a weight metric of one or a collection of items that, when a customer selects the one or more items, that weight can be used to generate a resulting by-weight item price listing in a checkout list. Herein, references are made to a set of items, which may include a set of a single item (where a set of items is an item) or a set of items could be plurality of items or any suitable description of a collection of items.

Two preferred approaches can include scale-based measurement of weight and volumetric inference for weight approximation. In some variations, both options may be operable within a single system and used to provide customer's options to accommodate different types of products. For example, a first subset of products may be managed and accounted using scale-based measurement and a second subset of products may be managed using volumetric inference.

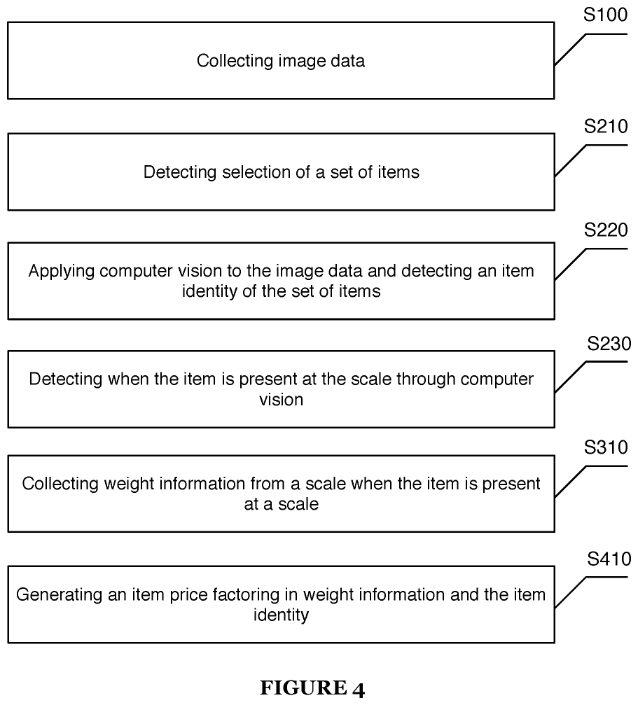

As shown in FIG. 4, a variation of the method for produce and bulk good management using a scale can include at a computer vision monitoring system, collecting image data S100; detecting selection of a set of items S210 displayed in the environment, the items selected by a first user through computer vision; applying computer vision to the image data and detecting an item identity of the set of items S220; collecting weight information from a scale when the item is present at a scale S310; and generating an item price factoring in weight information and the item identity S410. The scale-based method may additionally include detecting when the item is present at the scale through computer vision S230.

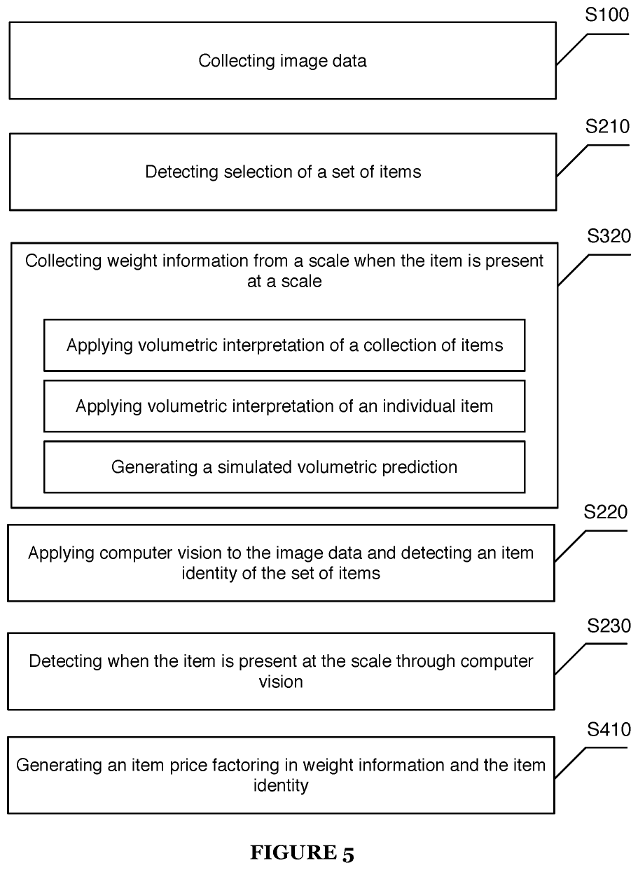

As shown in FIG. 5, a method for produce and bulk good management through volume estimation can include at a computer vision monitoring system, collecting image data S100; applying volumetric interpretation of a first set of items that is at least partially based on image data S320; detecting selection of the set of items S210 from storage by a user through computer vision; applying computer vision to the image data and detecting an item identity of the set of items S220; and generating an item price factoring in weight information and the item identity S410.

A method may additionally employ a combination of method for produce and bulk good management using a scale and a method for produce and bulk good management through volume estimation.

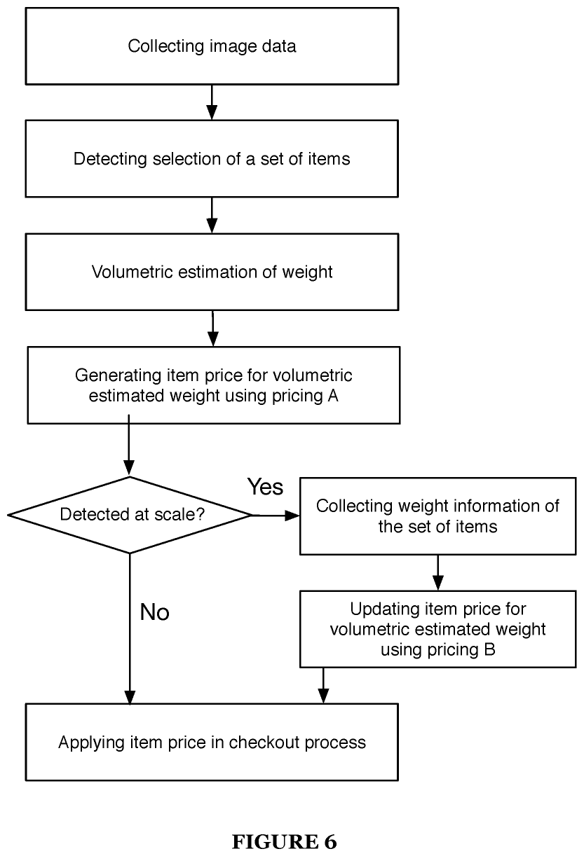

In one variation, a business model could support a system where users are presented with the option of using volumetric estimation because of its convenience or a scale-based measurement for assurance in the precision of item value. Different pricing may be enabled for the different approaches as shown in FIG. 6.

In one variation, a combination may be used such that a scale can be used to train or improve subsequent volume estimations. Produce change seasonally, based on where they are sourced, the weather, and various other reasons. Therefore, scale based assessment on a subset of items can improve volumetric interpretation. Scales can establish base measurements used to establish predictive models of weight and density as shown in FIG. 7.

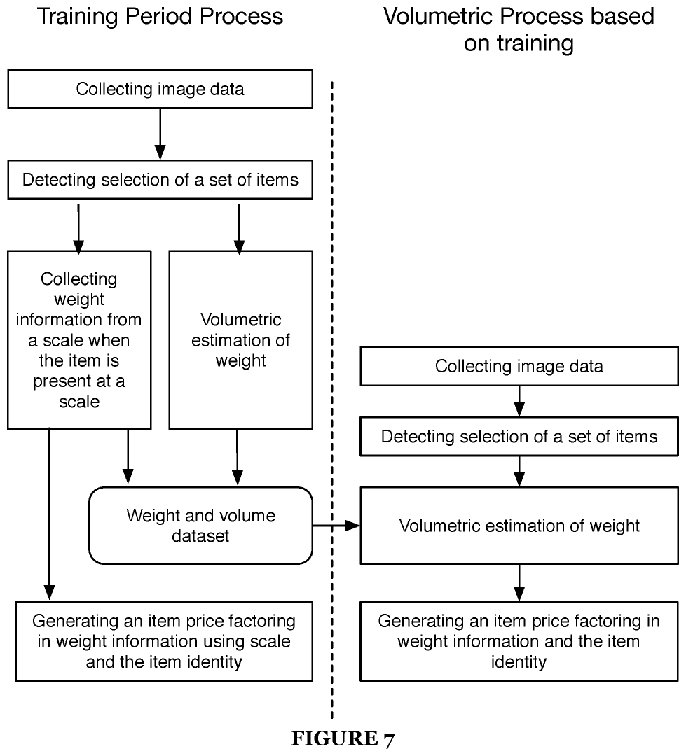

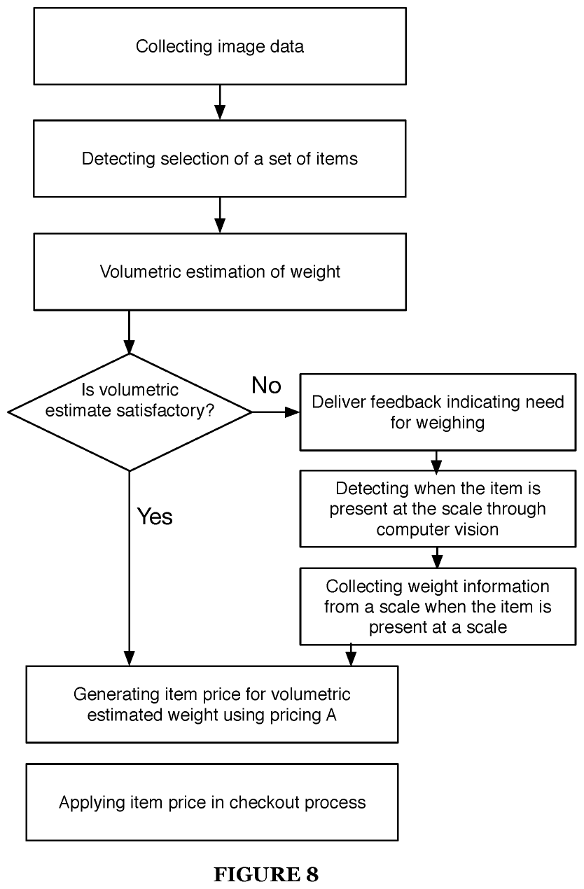

In another variation, a scale-based measurement of weight may serve as an integrated solution to situations where volumetric estimation is not feasible because of instances of an error/low confidence and/or products less suitable for volumetric estimation. A user could, for example, be prompted to use a scale for an item where a high confidence volume estimation and/or weight prediction is not obtained as shown in FIG. 8.

Block S100, which includes collecting image data, functions to collect video, pictures, or other imagery of a region containing objects of interest (e.g., product items). Image data is preferably collected from across the environment from multiple imaging devices. Preferably, collecting imaging data occurs from a variety of capture points. The set of capture points include overlapping and/or non-overlapping views of monitored regions in an environment. Alternatively, the method may utilize a single imaging device, where the imaging device has sufficient view of the items of interest. The imaging data preferably substantially covers a continuous region. However, the method can accommodate for holes, gaps, or uninspected regions. The method may be robust for handling areas with an absence of image-based surveillance such as bathrooms, hallways, and the like. In one variation, discrete regions may be monitored. For example, a storage bin of produce may be monitored with one set of cameras in a first region and then a scale and/or POS system may be monitored with a second set of cameras in a second region.

The imaging data may be directly collected, and may be communicated to an appropriate processing system such as the computer vision monitoring system. The imaging data may be of a single format, but the imaging data may alternatively include a set of different imaging data formats. The imaging data can include high resolution video, low resolution video, photographs from distinct points in time, imaging data from a fixed point of view, imaging data from an actuating camera, visual spectrum imaging data, infrared imaging data, 3D depth sensing imaging data, parallax, lidar, radar, sonar, passive illumination, active illumination, and/or any suitable type of imaging data.

The method may be used with a variety of imaging systems, collecting imaging data may additionally include collecting imaging data from a set of imaging devices set in at least one of a set of configurations. The imaging device configurations can include: aerial capture configuration, shelf-directed capture configuration, movable configuration, and/or other types of imaging device configurations. Imaging devices mounted over-head are preferably in an aerial capture configuration and are preferably used as a main image data source. In some variations, particular sections of the store may have one or more dedicated imaging devices directed at a particular region or product so as to deliver content specifically for interactions in that region. In some variations, imaging devices may include worn imaging devices such as a smart eyewear imaging device. This alternative movable configuration can be similarly used to extract information of the individual wearing the imaging device or other observed in the collected image data.

Collecting image data may include generating a depth-based model of environment. A depth-based model may be used in volumetric estimation of the set of items. Generating a depth-based model of the environment may additionally include collecting multiple images of varying perspectives to facilitate generating a depth-based model of the environment. Preferably, image data is collected from image capture devices arranged with partially redundant fields of view. For depth, at least two image capture devices are preferably arranged to have their line of site in non-perpendicular or opposing directions to facilitate. The angle between their lines of site should be an acute angle less than 90 degrees though some approaches may support angle alignment greater than 90 degrees.

In the regions of interest (storage location of products and regions for user-item interactions) the collective image coverage preferably has at least double redundancy meaning at least two cameras of differing points of view. Depth-based modeling can be 2.5 dimensional or 3-dimensional modeling of the image data. In one variation, image data from multiple distinct views of objects in the environment can be converted to a 3D model of a portion of the environment. In another variation, a 3D imaging device such as a structured light imaging system, light-field camera, multi-cameras imaging system, or other suitable imaging devices, can be used in collecting and generating depth-based image data. In another variation, a single imaging device (and the image data and/or video data) can be converted to a 3D model.

Block S200, which includes detecting item identity of a set of items through computer vision processing of the image data, functions to classify or detect the type of item such that some identifier and related information may be used in management of the item. The item identity is preferably associated with a descriptor of that item which may be or be further associated with a product identifier such as a PLU, SKU ID, or the like. Furthermore, block S200 may include identifying the item as a by-weight item or an item type triggering special property processing as described herein. A product database may store product information indexed or searchable by the item identifier. For example, detecting item identity can lead to obtaining item density data, volumetric data, and the like which can be used in further CV processing or checkout processing.

An item identity is preferably detected using CV-based object recognition. Alternatively or additionally, an item identity could be detected in part or whole by associating different regions of the environment with a particular item type or set of item types.

In one variation, a pre-configured planogram of the store could specify the location of different types of items. In another variation, the location and regions containing particular types of items could be detected by the CV system, an inventory or stocking system, or in any suitable manner. CV processing of sets of items in the environment may leverage regional information of expected or historical layout of items to detect the identity of an item.

In another variation, CV processing of image data of stocking activity and/or signage in the environment may be used to facilitate detection and classification of items. For example, detecting item identity can include detecting a stocking event through detecting of a work and stocking activity gestures which may include detecting items from a transient storage item (e.g., a stocking bin, box, or cart) to a permanent or substantially stationary (e.g., remaining in place in the environment for longer than 24 hours); and collecting item identifying information. Item identifying information could be collected from visible labels or signage on the storage item. Item identifying information could alternatively be collected from an inventory/stock management system used by the worker. For example, a worker marking completion of stocking items in an inventory management application can be used to assign a product identifier to the items stocked at that time.

In one variation, items may be individually identified. For example, each apple visible in a bin of apples will be identified as a type of apple designated by a PLU. In another variation items may be identified as a group or a region. For example, the apples in the bin of apples will be collectively identified as being apples designated by the PLU. The identifying of an item may additionally be updated. For example, an item may be re-identified after being picked up from a region identified as a particular type of apples. If a different type of apple or even a different fruit was misplaced its identification may be updated when isolated from the group.

Detecting an item identity may be performed at rest. In this variation, items are preferably identified while they are being stored and displayed within the store. Thereby, the identity of the item is established when a user-item interaction happens. Items may alternatively be identified in response to some event such as a user-item interaction. For example, an item may be identified when the item is picked up by the user. In another example, an item may be identified when placed on a scale or set out for weighing at a POS system.

Detecting item identity of a set of items when implemented may be a process that is accompanied by CV processing to track interactions and movement of the item. Detecting item identity of a set of items preferably includes detecting selection of a set of items S210 from storage by a first user through computer vision and applying computer vision to the image data and detecting an item identity of the set of items S220. In this way, CV processing of the image data can detect establish the identity of the set of items and at some stage detect user-item interaction such as a user picking up the item or moving the item to a cart. Blocks S210 and S220 may be performed in different orders depending on the scenario and implementation. Furthermore, block S200 and blocks S210 and S220 may be performed in different orders with the collecting of weight information S300.

In variations of the method, where a scale is used, the method may additionally include detecting when the item is present at the scale through computer vision S230. Detecting when the item is present at the scale may additionally detect the identity of the scale, as there may be multiple scales. Once identified, communicated weight data from the identified scale can be paired with the item identity for processing.

In an exemplary instance where a scale on the sales floor is used, the method may include detecting when a user places an item on the scale. This may prompt or initiate the collection of weight data from the scale. As discussed below various ways of collecting weight data may be used such as extracting the data from a visual interface of the scale, receiving data from the scale, requesting weight data from the scale, and/or other approaches.

In another exemplary instance where the scale is integrated into storage infrastructure and/or the floor, the CV monitoring system can track the location of an item and infer when one or more scale in the environment is situated to provide weight data. This can include detecting the decrease in measured weight from a bin scale when an item is moved. This may also be detecting the increase in weight of a person or cart from a previous measurement after a person selects a new set of items. Other suitable techniques may also be used for collecting weight data without explicitly setting the item on a scale.

In another exemplary instance where the scale is integrated into a POS system, when an item is placed on a scale of the POS system the CV monitoring system may initiate identifying the item while on the scale. Additionally or alternatively, the CV monitoring system may have previously identified the item and when the identified item is placed on the scale, the scale reading can be paired to the tracked item.

The method may further comprise of one or more additional, alternative, and/or supplementary CV monitoring processes such as detecting user-item interactions, tracking of items and/or users, additional classification and/or characterizing of items, establishing association of object interactions and/or other suitable CV-based processes.

The processing preferably utilizes one or more CV-based processes. More preferably, multiple forms of CV-based processing techniques are applied to detect multiple elements that are used in combination to track state of various digital interactions such as automated checkout. For example, processing the image data can include various CV-based techniques such as application of neural network or other machine learning techniques for: person detection; person identification; person tracking; object detection; articulated body/biomechanical pose estimation; object classification; object tracking; 3D modeling of objects, extraction of information from device interface sources; gesture, event, or interaction detection; scene description; detection of a set of customer-item interactions (e.g., item grasping, lifting, inspecting, etc.), and the like.

Various techniques may be employed in such CV-based processes such as a “bag of features” object classification, convolutional neural networks (CNN), statistical machine learning, or other suitable approaches. Neural networks or CNNS such as Fast regional-CNN (r-CNN), Faster R-CNN, Mask R-CNN, and/or other neural network variations and implementations can be executed as computer vision driven object classification processes. Image feature extraction and classification and other processes may additionally use processes like visual words, constellation of feature classification, and bag-of-words classification processes. These and other classification techniques can include use of scale-invariant feature transform (SIFT), speeded up robust features (SURF), various feature extraction techniques, cascade classifiers, Naive-Bayes, support vector machines, and/or other suitable techniques. The CV monitoring and processing other traditional computer vision techniques, deep learning models, machine learning, heuristic modeling, and/or other suitable techniques in processing the image data and/or other supplemental sources of data and inputs. The CV monitoring system may additionally use human-in-the-loop (HL) processing in evaluating image data in part or whole.

Detecting a customer-item interaction event includes detecting one or more types of interactions between the user and a product. Detecting user-item interactions can include applying CV-based processing that functions to model events related to item and customer interactions based on the image data. Preferably a variety of techniques may be used. Detecting user-item interactions may involve multiple individual forms of CV-based processing that analyzed together can be used to predict or classify interactions.

Detecting a customer-item interaction event can include detecting an item pickup event, which functions to detect when a user handles an item. Detecting an item pickup even preferably includes detecting an image/video event of a user grasping an item and optionally moving the item from storage.

Additionally or alternatively, detecting a customer-item interaction event can include detecting item selection which functions to detect when a user selects a user for an intended purpose (e.g., for checkout/purchase). This can include detecting placement of an item in a cart or bag or alternatively carried or taken by the user. In one exemplary instance this may include detecting an item pickup event for a set of items and placing in a cart or bar. In another exemplary instance this may include detecting an item pickup event for a set of items and tracking the user moving away from the region (without detecting a put-back event.

Detecting a customer-item interaction event includes detecting an item put-back event, which functions to detect when a user returns or otherwise places an item-to-item storage. This may include detecting the item returned to the same or different location from when it was originally stored. A put-back event may occur when a user selects an item or picks up an item but changes their mind. A put-back event may similarly be performed as a stocking event by a worker. Accordingly detecting and classifying of a user as a customer or worker may determine differentiating between stocking and product returned to storage by a customer.

Tracking of items and/or users preferably functions to continuously or periodic track objects through the environment. In an exemplary store-based implementation, customers are preferably tracked through the environment; and/or items selected for purchase by a customer (e.g., items in a cart, bag, or otherwise picked up by the customer) are preferably tracked as part of maintaining a virtual cart of the customer. Customer tracking and item location detection are preferably used. Customer location may alternatively be based on detection in the field of view of one camera that is part of a distributed network of cameras. Customer or user tracking may alternatively be facilitated by positional tracking of a customer-associated computing device (e.g., a smart phone or wearable computer).

Tracking of an object is preferably used such that modeled state and information associated with an object can be persisted as it moves and is involved in various interactions. In one variation, tracking includes directly tracking through CV monitoring or other location sensing technology. As an additional or alternative variation, tracking may include associating an object (e.g., a product item) with a second object (e.g., a customer) and indirectly tracking the object by directly tracking the second object. For example, once a product is established as being associated with the virtual cart of a customer, that product and its associated weight or other properties can be tracked by tracking movement of the customer.

CV processing of image data can additionally be used for other forms of classification and characterizing items. For example, CV-based analysis of items can be used to classify size, quality, grade, ripeness, color, detect defects, and the like. Such properties may be used in addition to or in some cases in place of weight when generating a price or otherwise managing the item. Related to such item classification and characterizing, tracking of an item, or set of items may additionally be used to track duration of stocking the item. Some items may have different shelf lives and value may go up or down based on “ripeness” or age. For example, an unripe avocado, overly ripe avocado, and ripe avocado may all have differing values.

CV processing may additionally be used to establish an association between a user and a related user account. For example, physical identification of a user may be used to identify an associated user account. The user account can then be used for various applications such as automated checkout using a saved payment mechanism. Other techniques may be used for establishing an association of a user with an account such as detecting a personal computing device and establishing an association with an observed user in the image data. In another variation, a user may check in at a kiosk which signals their user account, and then CV-based tracking can be used to persist the association of the user account with that particular person for the duration they are present/observed in the environment. Establishing an association can additionally be used for an item and a second object like a scale, bin, and/or POS system. For example, when a smart scale reports a measured weight, CV processing of image data covering the smart scale can be used in associating a particular item or set of items with the measured weight. Thereby the smart scale may have no direct knowledge of the item being measured, but by communicating the weight data to the CV monitoring system weight and product identity can be used in generating a by-weight price.

Preferably, applying CV-based processing can include tracking a set of users through the environment; for each user, detecting item interaction events, updating items in a checkout list based on the item interaction event (e.g., adding or removing items). The checkout list can be a predictive model of the items selected by a customer, and, in addition to the identity of the items, the checkout list may include a confidence level for the checkout list and/or individual items. The checkout list is preferably a data model of predicted or sensed interactions. Other variations of the method may have the checkout list be tracking of the number of items possessed by a customer or detection of only particular item types (e.g., controlled goods like alcohol, or automatic-checkout eligible goods).

Block S300, which includes collecting weight information of the set of items, functions to obtain item properties used in setting the item price. Weight can be the primary property. However, additional, or alternative properties such as size, quality, grade, ripeness, color, detect defects, storage duration, and the like may be collected for the set of items. Collecting size may use the various volumetric estimation approaches described herein, color, ripeness, defect detection and other properties use CV classification. Tracking items from stocking to customer selection and purpose may be used in determining the length of time the product has been stored.

Herein, we primarily discuss and describe the process as it may be used for generating a by-weight price record for a set of items. However, one skilled in the art may appreciate how block S300 may be supplemented with additional or alternative processes for property collection.

Collecting weight information may include measuring weight using a scale. Collecting weight information may alternatively be collected through volumetric inference. Accordingly, collecting weight information may include collecting weight information from a scale when the item is present at a scale S310 and/or applying volumetric interpretation of a first set of items that is at least partially based on image data S320. In some variations, both approaches may be used in combination either for assessing weight of one item or across multiple different items for various possible reasons.

Block S310, which includes collecting weight information from a scale when the item is present at a scale, functions to measure the weight of an item. The scale (i.e., weight sensor) may be an electronic weight sensor (e.g., a load cell), gauge, a mechanical mechanism, or any suitable system for measuring weight. Measuring weight may be detecting of the weight when the set of items are added to a scale or inferring the weight of the items by a change in measured weight when the items are removed from the scale.

Collecting weight information with a scale may be used as a primary (or only) mode of achieving a by-weight price record for a set of items. In other implementations, collecting weight information may be used in monitoring items to support other artificial intelligence, machine learning, or statistical modeling approaches to predict weight. Collecting weight information with a scale may alternative be an optional path of a checkout experience for a customer.

Collecting of weight information with a scale may be achieved through different solutions and processes, which may depend on the configuration of the scale that is used. In some instances, an environment may be configured to support multiple techniques. Variations may include collecting weight information with a POS integrated scale, collecting weight information with a store scale, collecting weight information from an infrastructure-integrated scale.

Collecting weight information with a POS integrated scale functions to collect weight at a checkout station. POS systems in a grocery store are generally equipped with a scale. Weight information could be checked at this point.

Within an environment with automated checkout, a customer may be expected in this variation to present selected produce for measuring before checkout out. In one variation, the CV monitoring system can facilitate regulating this procedure wherein the method may include detecting selection of an item measured by weight and verifying the customer presents the by-weight items for weighing. In one variation, the method may include communicating the presence of one or more of these items to the POS system. A worker (or the customer if it's a customer self-checkout POS system) can be presented with the items that are needed to be weighed. Alternatively, the customer may be expected to provide the items for weighing. If they do not, then an exception/warning may be issued when trying to finalize the checkout process.

When performed at a scale that is integrated into the POS system, there may be multiple sets of items requiring weighing. Accordingly, multiple items may be weighed in a sequential manner. Preferably, the items can be scanned in any suitable manner, and the CV monitoring system tracks the identity of the items present on the scale. Alternatively, the POS system may communicate to the operator the type of item to be scanned when. As another alternative, the operator may input the item identity when scanning, which may be used in instances when item identification is confirmed through human input.

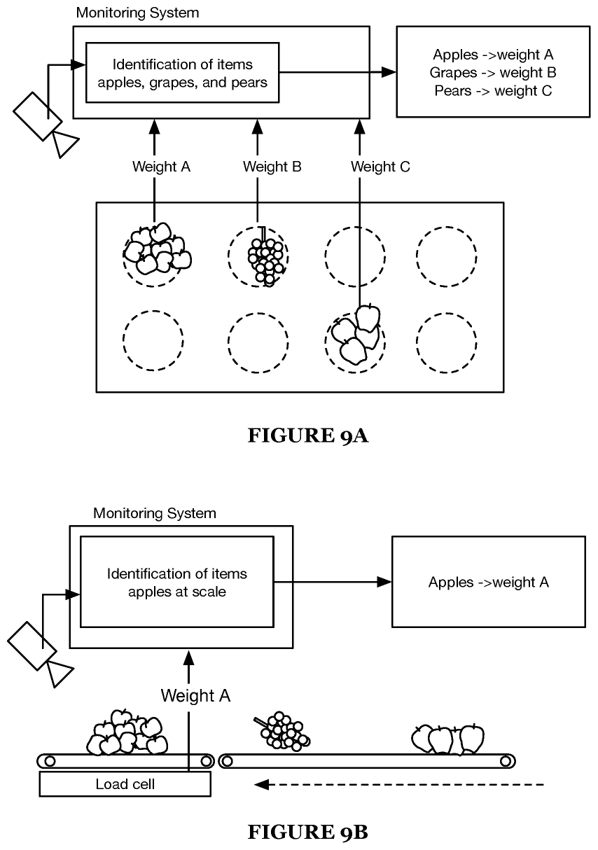

In one variation, an array or matrix of scales may be distributed across a surface at the POS system such that all produce items may be placed on the surface. Multiple items can be weighed systematically through the scale as shown in FIG. 9A. The array of scales can be a grid distributed regularly at various points. When the items are placed across the surface individual weight measurements may be collected for each set of items. The array of scales may work collectively such that a set of items may be placed anywhere. The CV monitoring system can preferably detect locations of the items and then determine how to interpret weight data from multiple scales to assess the weight of one or more sets of items. In another variation there may be designated zones, possibly marked, where isolated scales are present. Such a table scale concept is at least partially operationally through cooperative interaction with the CV monitoring system. Individual entry of the items is not required because of the CV monitoring thereby allowing this quick group presentation and arrangement of items so that they all get weight quickly. The CV monitoring system can detect when the arrangement of items is not suitable a communicate a warning or error signal. Feedback can be output from the table scale indicating the items of the table scale need to be repositioned. Preferably multiple sets of items are piled in little groups of the same type of item. The piles may additionally benefit from some amount of separation. Another implementation of such a concept may be a conveyer belt with one or more zones configured for weighing. Items are placed on the conveyer and weight information is collected systematically as each moves across the conveyer as shown in FIG. 9B.

Collecting weight information with a store scale functions to collect weight data from a customer-facing scale. A shopping environment may include one or more scales positioned on the sales area and made available for customer use. The sales area will generally be at or near where produce, bulk goods, or other suitable products are displayed. The store scales may be traditional scales (digital or analog) such as ones that may have previously been used. Store scales may additionally include smart scales that are communicatively integrated with the monitoring system.

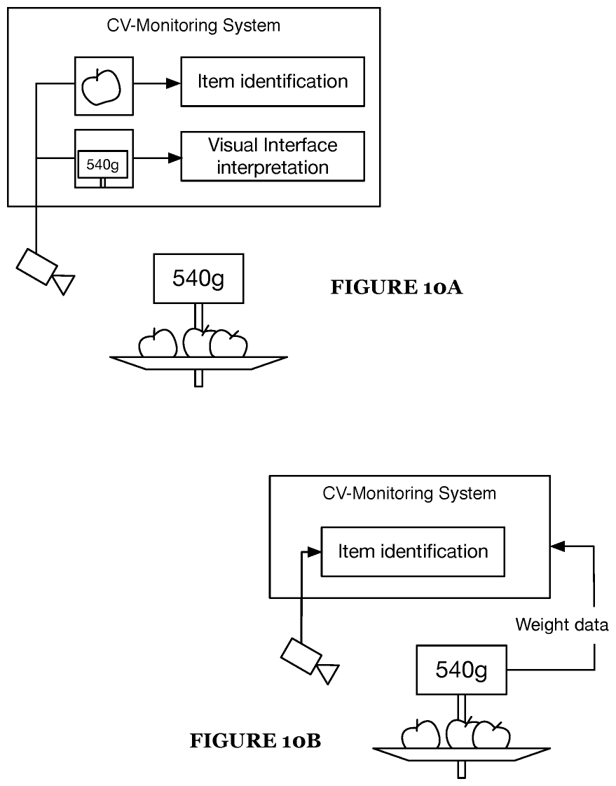

In a variation using a traditional scale, no data communication is used to communicate weight information. In many situations, the scale is communicatively decoupled form the monitoring system. The scale will preferably have a visual display of weight, which is used in communicating weight visually to observers. In such a variation, collecting weight information from a scale includes extracting displayed weight on the visual display of the weight as shown in FIG. 10A. Extracting displayed weight on the visual display will may include selectively processing image data of the scale and classifying the visually displayed information into weight information. This may include: modeling location and movement of a need in a dial; character recognition in a digital display, and the like. Similar to variations, the process will additionally include matching the extracted displayed weight to a computer vision identified and optionally tracked item.

The location of a scale for weight information extraction may be configured when setting up the image data collection. Alternatively, CV based scale identification may be used to automatically enroll a scale and begin extracting weight information.

The scale will preferably have a visual display of reported weight information. The visual display of weight may be a dial or gauge, a digital screen displaying in characters the weight information, and/or any suitable display. The display may generally be configured for human reading of the weight information. The display may alternatively be configured to display graphical machine-readable information such as a QR code or another suitable graphical code with visually embedded information. Accordingly, the method may include, at the scale, displaying the visual display of the weight in a graphical machine-readable code. Such a scale may be specially designed for visually interfacing with CV monitoring systems.

In a variation using a smart scale, the scale is a network-connected scale where data communication is used to communicate weight information. In such a variation, collecting weight information from a store's smart scale can include, at the smart scale, communicating a measured weight to the monitoring system; and matching the communicated weight to the computer vision tracked item as shown in FIG. 10B.

Preferably, the smart scale reports the weight information to the monitoring system. The monitoring system can then match the weight information to a set of items present on the smart scale when appropriate.

In another variation, the monitoring system may request weight information when needed. In such a variation, the process may include detecting the identity of the smart scale and actively requesting weight information when the set of items are present at the smart scale.

In some instances, the weight information is not communicated from the smart scale. Instead, the item identity is communicated to the smart scale for use. As discussed more below, a smart scale may additionally be used for generating an artifact for managing of goods. Block S400 may include communicating item identity to a smart scale; and at the scale, printing an item price tag with item identifier associated information and the weight.

Collecting weight information from an infrastructure-integrated scale functions to apply scales that collect weight measurement through objects and structures in the environment. Infrastructure-integrated scales are preferably used so that weight information can be collected during normal actions and events involving the items that may not be obvious weighing actions. In one variation involving infrastructure-integrated scales, the scale is part of a display unit storing the set of items prior to selection. The display unit will generally store or be used to display a plurality of items. For example, infrastructure-integrated scales can be used to track weight of a collection of apples stored on display in a large bin. In one variation, the display unit may display multiple types of items.

Alternative types of infrastructure-integrated scales may include scales into the floor. A number of regions in the store may be equipped with scales. Floor-integrated scales may be positioned at various positions in the store to detect weight of users and track their weight as they shop. Alternatively, floor-integrated scales may be positioned strategically such as an around a display unit. As another alternative type of infrastructure-integrated scale, a stocking cart or other suitable equipment used to temporary store items when stocking the items at a display unit (a scale display unit or a traditional display unit). Monitoring of a stocking cart and tracking item stocking may include weighing items or item collections while in loading equipment and detecting the change in weight as items are removed and positioned in a shelf or display unit. The newly added items can then be associated with that change in weight as measured by the stocking cart and/or the storage unit. Dividing over the number of items moved (detected by V) could be used in determining an individual item measurement. Floor-integrated scales, stocking-equipment scales may be used in a similar fashion as the display unit scales. In some instances, a combination of types of infrastructure-integrated scales may be used.

In one variation, a display unit scale may be used in collecting of weight information upon detecting a decrease in weight. A decrease in weight corresponds to a removal of a set of items. CV monitoring may detect such a user-item event. If the user-item event timing corresponds to the timing of the measured weight decrease and the location of the scale corresponds to the location of the user-item event, then the weight may be associated with the set of items.

In another variation, the display unit scale may be used to assess weight information when stocking or adding items to the display unit. During a stocking event, CV monitoring may include detecting an addition of a set of items to the storage unit during the stocking event. Coordinated with the CV monitoring, collecting weight information at a time window of adding the items and detecting an addition of weight and assigning the weight to individual items detected through computer vision. In such processing scenarios, the CV monitoring has facilitated that the items are present at the scale of the display unit by detecting the items present on the display or even by detecting location in the environment, which is associated with the display unit.

The scale in the display unit may be a single scale. The scale in the display unit may alternatively be an array of scales to measure weight at multiple points or regions of the display unit. In the case of multiple scales, the matrix of weight measurement may be used to generate a weight distribution map and/or to measure weight data of items localized to a particular region.

In either type of scale, the display unit may store a single type of item (e.g., one type of apple) or multiple types of items. Item identity detection is preferably used in distinguishing item type thereby alleviating dependence on having one scale per item type. A large display unit with a load cell integrated into it may be able to store two, five, ten, or any suitable number of items and still be usable by the method to provide weight information assigned to specific items or sets of items.

CV monitoring of item related events such as detecting stocking of a set of items or selection/removal of a set of items and detection of their position within the display unit may be used in determining localized weight information and assigning the localized weight information as a weight property to the associated set of items. For example, the scale may detect a weight change at a time period t1; the CV monitoring system identifies an item i1 being selected at time period t1; and the weight change can be set as the detected weight item. Similarly, in another exemplary instance with the same scale, the scale may detect a weight change at time period t2; the CV monitoring system identifies an item i2 being selected at time period t2; and the weight change can be set as the detected weight of item t2. The scale can provide item specific weight information when coordinated with the CV monitoring system.

Block S320, which includes applying volumetric interpretation of a first set of items that is at least partially based on image data, functions to use CV-based processing of image data to generate a volumetric estimation or otherwise estimate the weight. Generally, the volumetric estimation is converted to a weight and that weight can then be used set a price based on a price-per-weight pricing scheme. Applying the volumetric interpretation can include calculating predicted weight information resulting from applying an expected item density to the volumetric interpretation and calculating an item price by applying a price-per-weight pricing model to the weight. A virtual cart could be updated with the item price and optionally the weight for a given item. Accordingly, applying a volumetric interpretation will preferably include extracting a volumetric estimation of the set of items using computer vision, identifying density information of the item based on the item identity, and predicting weight information of the set of items using the volumetric estimation and density information.

An item type is preferably associated with at least one item density metric. For example, Gala Apples will have an item density record and Red Delicious Apples will have a second item density record. Item density could be a pre-configured and static value. Alternatively, an item density could dynamically change with new information. For example, the stocking process may facilitate updating of density records. In another variation, the item density may be predicted based on various traits of the item. For example, size, shape, color, and/or other properties may be detected through CV processes or other techniques and then that could be used to predict an item density for that particular item. In some variations, the method may additionally include training volumetric interpretation of an item. In one implementation, a store integrated scale (e.g., a display unit with a scale) could be used for onboarding and training the system on new items as discussed herein. Items new to the system may have an initial density value set or be processed using scale-based measurement.

Volumetric interpretation will preferably include extracting a volume prediction for one or more items. The volumetric interpretation is preferably applied to the user selection of items during a shopping experience. Accordingly, applying a volumetric interpretation in variation can include applying volumetric interpretation items involved in an item selection or another change in storage. In this way, a volumetric interpretation is responsive to customer selection of a set of items for purchase, to a stocking event, and/or to other suitable events. Volumetric interpretation may be executed as a specialized process of an automatic shopping system that is selectively applied for appropriate items.

Volumetric interpretation may apply deep learning, machine learning, statistical modeling, and/or any suitable technique. In one example, feature inputs like coloring, shape, shadowing, and the like may be used to predict a volume.

Volumetric interpretation in another variation may use structured light projectors or other suitable depth sensing technology to create a multi-dimensional map with depth information. In one variation, the CV monitoring system may collect image data from multiple points of view. Image capture devices arranged to provide stereoscopic data may be used to estimate depth of an image, which may in turn be used in estimating volume.

In another variation, volumetric interpretation may include performing body/biomechanical pose estimation, which may be isolated to one or both hands of a user. The biomechanical pose of the hand when holding a set of items may be used in predicting volume.

Applying a volumetric interpretation of item selection can calculate a per item volume prediction or alternatively an item collection volume prediction. Accordingly, generating a volumetric estimation from the image data can include generating an individual volumetric estimation of volume for an item. When a plurality of items are detected or identified, the method may include for each item in the second set of items, generating an individual volumetric estimation. Volume is preferably the extracted metric. Volume and an item density metric can be used in Block to determine weight, which may then be used for pricing items priced by weight. In some variations, the method may directly interpret weight without generating a volume prediction.

Item density information may be a configured metric for each type of item. Alternatively, item density may be dynamically calculated or updated through a combination of some limited use of block S310 and S320 to establish a record of density measures. For example, each new item may undergo a training period wherein weighing with a scale is used in combination with volumetric interpretation so that a data set can be built to predict density metrics to be used in subsequent volumetric interpretations.

A variety of approaches may be used individually or in combination. Different variations of applying volumetric interpretation can include applying volumetric interpretation of a collection of items, applying volumetric interpretation of an individual item, generating a simulated volumetric prediction, tracking item stocking, and/or tracking items and updating volumetric interpretations of a tracked item.

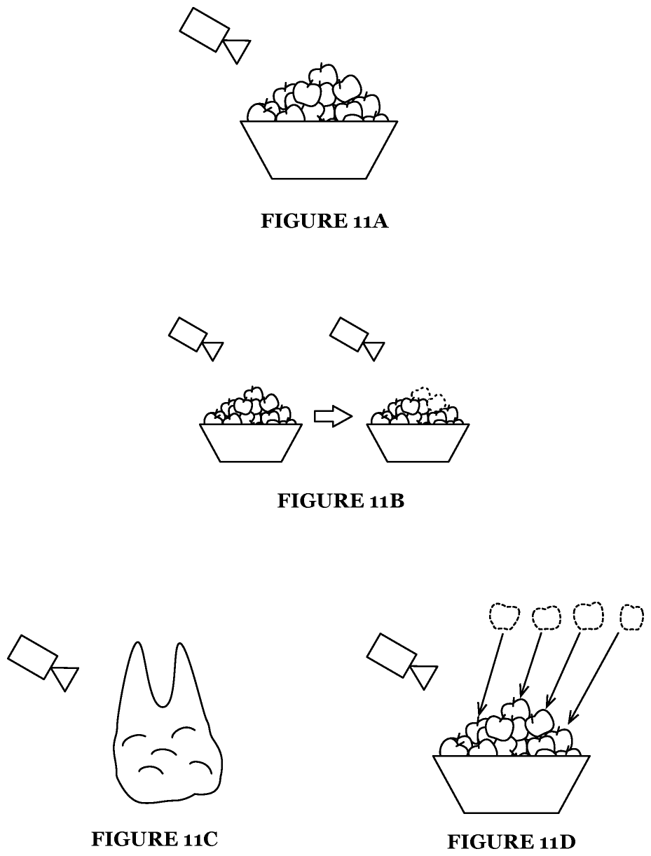

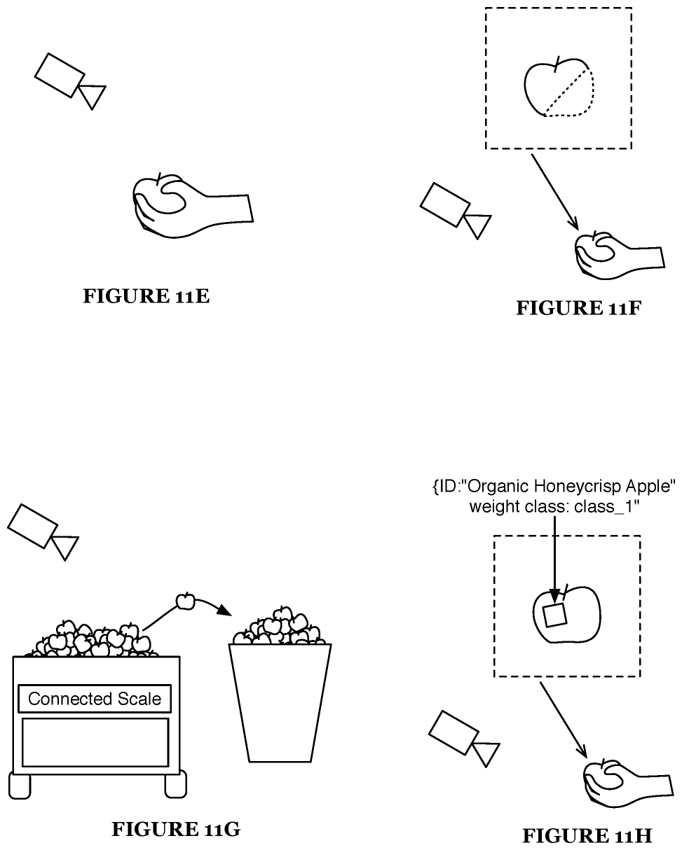

Applying volumetric interpretation can include applying volumetric interpretation of a collection of items which functions to perform volumetric modeling of multiple items grouped together. This will generally include modeling volume of a plurality of items stored within the environment. For example, applying volumetric interpretation of a collection of items may include creating a volumetric interpretation of a stack of apples displayed on a produce stand as shown in FIG. 11A. A base volume may be measured for the full collection of items. Such a base volume metric may be used when an item is removed or added. Accordingly, a volumetric model of stored item collections may be used to detect volume of items by detecting the change in the item collection volume as shown in FIG. 11B. A volume of items is initially interpreted and then the volume of items can be interpreted a subsequent time after a change in the collection of items. The change in volume can be used to estimate the volume of items added or removed. When an item is removed from the item collection, the base volume will decrease and comparing the current base volume to a previous base volume can yield a volume estimation for the items removed. Similarly, if a set of items is added, the change in the base volume may yield a volume estimation for the items added.

Accordingly, the generating a volumetric estimation from the volumetric data may include estimating volume of a first collection of items at a time prior to removal of the second set of items, detecting removal of the second set of items from the first collection of items, estimating volume of the first collection of items after removal of the second set of items; and generating a predicted weight of the second set of items based on a change in the estimated volume of the first collection of items.

A volumetric interpretation of the expected volume may not be restricted to items on display. In another variation, volumetric interpretation can be applied on a collection of items selected by a customer. In one implementation, the volume for a collection of items may be stacked in a cart or stored within a bag as shown in FIG. 11C.

Applying volumetric interpretation can additionally or alternatively include applying volumetric interpretation of an individual item. In this variation, volume of an individual item could be interpreted. A volume snapshot could be performed for multiple items in a collection of items. For example, each visible item in a collection of items may have an individual volume estimation generated for it as shown in FIG. 11D. In another variation, the volume of an item selected by a customer could be detected as shown in FIG. 11E. Individual volumetric interpretation can be initiated for an item in response to a user-item interaction event.

In another variation, applying volumetric interpretation can include generating a simulated volumetric prediction as shown in FIG. 11F. Simulated volumetric prediction can use various historical data, 3D item modeling, simulated physics, patterns in item shapes, and/or other properties to predict the volume of an item. In particular, generating a simulated volumetric prediction can predict volume of unviewed portions of an item. In many cases, only a portion of an item will be visible in the image data. Typical patterns in item shape and form could be used to predict the volume for the item. For example, the method may involve synthesizing complete volumes of one or more items based on partial samples of an item. Surface modeling, color sampling, item shape, and/or other properties can be used to predict unseen volume. As another variation, those items could be simulated as being stacked in the detected orientation and arrangement, which can inform possible volume properties. Overtime as more regions of an item are viewed and processed, the predictive model can be updated.

In another additional or alternative variation, applying volumetric interpretation can include tracking item stocking, which functions to obtain volumetric interpretation or direct weight properties by monitoring the stocking of items. As shown in FIG. 11G, volumetric interpretation may be triggered in response to an apple be moving from a stocking cart to a display unit. Volumetric interpretation can be performed on item collection or individual items in the stocking cart and/or the display unit. Volumes (and possibly weight) can be measured and then tracked across different item positions. For example, different samples of volumetric estimation, and weight estimates can be obtained when stocking, when statically displayed, and/or when selected by a customer. A final resulting volume estimate could be generated based on the longitudinal observation of the item or sets of items.

In another additional or alternative variation, applying volumetric interpretation can include tracking items and updating volumetric interpretations of a tracked item. Items may be uniquely identified and/or tracked from different locations. Different information can be collected over time and used to update the volumetric interpretation. In some variations, stickers or other forms of markings can be applied to items to facilitate tracking and identifying items. In one example, an apple may be identified and tracked over time as shown in FIG. 11H. At different times different views of the apples may be viewable by the CV monitoring system, and the different views can provide different item surface information that can be used in predicting a volumetric interpretation.

Markings may additionally or alternatively be used in identifying and/or differentiating items according to information associated with a marker. A marker could be used to communicate item type, item weight, item price, a unique item identifier, and/or other suitable information. A marking could be a machine-readable code like a QR code or preferably any suitable type of graphic readable by the CV monitoring system. For example, one variety of apples may have a first sticker, and a second type of apples may have a second type of sticker. In yet another variation, apples may have different markers applied that communicate type and weight class, where the apples are weighed and assigned one of a set of weight classes before offering for sale.

In one variation, a concrete volumetric estimation may not be used and instead various observable feature inputs can be collected and used directly in generating a weight estimation. Shape, size, appearance, surface shadows, shadows cast by the item, detected orientation when displayed, orientation of adjacent items, and/or other suitable properties may be used in predicting weight.

As mentioned above, volumetric estimation may be used in combination with collecting weight information from a scale. Coordinated use of both approaches may be used to facilitate different processes such as training volumetric estimation, providing user experience options, and providing a fallback solution.

In a variation for training volumetric estimation, block S310 and the collection of weight information from a scale can be used in building a dataset of weight information. Weight information is preferably collected for a set of items along with performing a volumetric estimation. A calculated density of the set of items can be recorded in a dataset for the corresponding item type. Density information collected in this way may be used as the one source of density information, but this measured density information may alternatively supplement or augment other density information. The density information may later be used for other instances of use when volumetric interpretation is used without use of a scale. A weight by volume density metric can be multiplied by the volume estimate to result in an estimated weight.

Alternatively, measured weight information and a corresponding volume estimation may be used to directly predict weight information based on the generation of a volume estimation. A deep learning model could be trained on predicting weight by volume estimation and/or other suitable inputs related to a set of items.

In another variation for providing user experience options, a process for adding a by-weight item using volumetric interpretation and by using a scale can be available. In some implementations, a user may have the option of using either.

A method with optional approaches to collecting weight information may include at a computer vision monitoring system, collecting image data S100; detecting selection of a set of items S210 from storage by a first user through computer vision; applying computer vision to the image data and detecting an item identity of the set of items S220; generating a volumetric estimation from the collected image data of the set of items, generating a predicted weight, and setting weight information of the item as the predicted weight S320; detecting when the item is present at the scale through computer vision S230 and collecting weight information from a scale if and when the item is detected as present at the scale S310 and overriding the predicted weight with the measured weight; and generating an item price factoring in weight information and the item identity S410. In this way a volumetric estimation may be performed initially and then a measured weight can override the estimated weight using volumetric estimation and other prediction techniques. If the item is not detected at the scale, the method will preferably set the predicted weight as the weight when applying the item identity and weight information (e.g., when generating the item price).

In practice, different pricing models may be used. A first price may be set for the by-weight pricing when using volumetric estimation to collect weight information and a second price may be used for when a scale is used in collecting weight information. These prices may be set based on a business model of accounting for performance of volumetric estimation but simpler user experience and the performance of measuring with a scale but a potentially more involved user experience. In one variation, the two prices may be dynamically changed based on training data, historical confidence, and the like. This may enable the system to automatically adjust pricing to promote use of a scale to build up training data or to promote use of volumetric estimation so the use of scales or a POS system is disincentivized.

In some variations, the different options may not be user selected. Different types of items may have one or the other as valid approaches to collecting weight information.

In such a variation, the method may include at a first instance: collecting image data S100; detecting selection of a first set of items S210 by a first user through computer vision; applying computer vision to the image data and detecting an item identity of the first set of items S220; collecting weight information from a scale when the first set of items is present at a scale S310; and generating an item price factoring in weight information and the item identity of the first set of items S410; and at a second instance: detecting selection of a second set of items from storage by the first user through computer vision S210; applying computer vision to the image data and detecting an item identity of the second set of items S220; generating a volumetric estimation from the collected image data of the second set of items and generating a predicted weight S320; and generating a second item price of the second set of items factoring in the predicted weight and the second item identity S410.

The items may be marked with different “weighing” options. Displays of items may include signage indicating if an item is available for selection using automatic volumetric-based weighing, scale-based weighing, or both.

In another variation, a combination of techniques may be used in providing a fallback solution. If for example, the confidence level in a volumetric estimation is low (e.g., less than 90% confidence) or the volumetric estimation cannot be completed for some reason, then scale-based measuring may be prompted.

Accordingly, the method may include generating feedback prompting user-facilitated weighing, which can function to selectively direct a user to weigh one or more item. Feedback is preferably generated in situations where the system detects low confidence in the volumetric interpretation and/or an error. Feedback can be generated and delivered through a personal computing device of the customer (e.g., using an application installed on the device), a feedback mechanism in the shopping environment (e.g., through a digital display or audio system), and/or the POS system user interface. The feedback can be audio feedback, visual feedback, tactile feedback, and/or any suitable form of feedback.

Generation of feedback is preferably accompanied through a subsequent process to resolve volumetric interpretation and/or collection of weight information. In one variation, a smart scale measures the weight of an item and then communicates the weight back to the system. In another variation, feedback may prompt a user to perform some action like holding up the item to facilitate volumetric interpretation. In another variation, a POS system user interface may indicate a volumetric estimation error or other suitable type of exception/warning, which prompts an operator (e.g., a worker) to weigh the effected set of items when performing a checkout process.

In one implementation, when a customer picks up an item or items for which a volumetric interpretation cannot be accurately determined, an audio tone will sound signaling to the customer to use a connected scale in the store to weigh the item(s).

Block S400, which includes applying item identity and weight information to management of the item, functions to use the item identity and the associated weight information as an input for other processes or systems. In block S400, the product identity is determine and information on physical properties (e.g., weight) of the product of interest are determined. This may be used in augmenting business operation systems. For example, changing ordering or stocking of produce or altering the payment to suppliers based on quality and requested properties of ordered items.

In one preferred variation, block S400 can include generating an item price factoring in weight information and the item identity S410. When used in an environment with an automated checkout process, the item price is preferably used in adding a product line item to a virtual cart/checkout list managed through the CV monitoring system.

This may include adding the corresponding identified product with the item price set based on the weight information. Once added to the virtual cart, the method may include initiating a checkout process including the item price for the item. Within a fully automated checkout process, a user may thus be enabled to pick up a produce item that is priced by weight and then leave the store, with the checkout process charging the item price to a stored payment mechanism. When used in a semi-automated checkout process involving a POS system, the method may include communicating an added item request with the item identifier and the item price to the POS system. In some cases, just the item identifier may be sent as the weight information may be collected at the POS system.

In yet another variation, block S400 may be used in generating a price tag, which may be used with an automated checkout process or even a traditional shopping process. Block S400 may include communicating item identity to a scale with a printer; and at the scale, printing an item price tag with item identifier associated information and the weight. As the weight information may be collected by the scale, weight information may not be transmitted. Additionally or alternatively, such a process may be used in communicating the item information, weight information, and/or item price to a network-connected printer, and printing the item price tag at the printer. The monitoring system or more specifically the computer vision monitoring system may originate the communication of the information.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method for produce monitoring systems comprising:
at a computer vision monitoring system, collecting image data;
detecting selection of a set of items by a first user through computer vision, the items having been displayed in an environment;
applying computer vision to the image data and detecting an item identity of the set of items;
collecting weight information from a scale when the item is present at the scale; and
generating an item price factoring in weight information and the item identity.

2. The method of claim 1, further comprising detecting when the item is present at the scale through computer vision.

3. The method of claim 1, further comprising communicating an added item request with the item identifier and the item price to a point of sale system.

4. The method of claim 3, wherein collecting weight information comprises collecting weight information from the scale, which is integrated into the point of sale system.

5. The method of claim 1, wherein collecting weight information comprises collecting weight information from the scale positioned on the sales area of the environment.

6. The method of claim 5, wherein the scale is a network-connected scale; and wherein collecting weight information from the scale positioned comprises, at the scale, communicating a measured weight to the computer vision monitoring system; and matching the communicated weight to the set of items.

7. The method of claim 5, wherein the scale has a visual display of weight; wherein the scale is communicatively decoupled from the monitoring system; and wherein collecting weight information from the scale comprises extracting a displayed weight on the visual display of the weight.

8. The method of claim 7, further comprising, at the scale, displaying the visual display of the weight in a graphical machine-readable code.

9. The method of claim 5, further comprising at the computer vision monitoring system, communicating item identity to a printer; and at the printer, printing an item price tag with associated information of the item identifier and the weight information.

10. The method of claim 1, wherein the scale is part of display unit storing the items prior to selection; and wherein the display unit holds multiple types of items.

11. The method of claim 10, wherein collecting weight information is performed upon detecting a decrease in weight.

12. The method of claim 10, wherein during applying computer vision processing of the image data and detecting an addition of the set of items to the display unit during a stocking event; and wherein collecting weight information comprises detecting a weight change when detecting the addition of the set of items to the display unit and assigning the weight information to the set of items detected through computer vision.

13. The method of claim 1, further comprising: generating a volumetric estimation from the collected image data of the set of items and generating a predicted weight; if the set of items is not detected at the scale, setting the predicted weight as the weight when generating the item price.

14. The method of claim 1, further comprising:
detecting selection of a second set of items from storage by the first user through computer vision;
applying computer vision to the image data and detecting a second item identity of the second set of items;
generating a volumetric estimation from the collected image data of the second set of items and generating a predicted weight;
generating a second item price of the second set of items factoring in the predicted weight and the second item identity.

15. The method of claim 14, wherein generating a volumetric estimation from the collected image data of the second set of items comprises through computer vision processing: estimating volume of a first collection of items at a time prior to removal of the second set of items, detecting removal of the second set of items from the first collection of items, estimating volume of the first collection of items after removal of the second set of items; and generating a predicted weight of the second set of items based on a change in the estimated volume of the first collection of items.

16. The method of claim 14, wherein generating a volumetric estimation from the image data of the second set of items comprises, for each item in the second set of items, generating an individual volumetric estimation of volume.

17. The method of claim 14, wherein generating a volumetric estimation from the image data of the second set of items comprises generating a simulated volumetric prediction of the set of items.

18. The method of claim 1, wherein collecting image data comprises collecting image data from a plurality of image capture devices oriented with an aerial view and distributed at distinct regions across the environment.

19. (canceled)

20. A machine-readable storage medium comprising instructions that, when executed by one or more processors of a machine, cause the machine to perform operations in connection with a computer vision monitoring system comprising:
collecting image data;
detecting selection of a set of items by a first user through computer vision, the items having been displayed in an environment;
applying computer vision to the image data and detecting an item identity of the set of items;
collecting weight information from a scale when the item is present at the scale; and
generating an item price factoring in weight information and the item identity.

21. A system for bulk good monitoring systems comprising
a computer vision monitoring system configured to collect image data of users and items in a shopping environment; and
a computer vision processing system configured to:
detect selection by a user of a set of items displayed in the shopping environment,
apply computer vision to the image data and detecting an item identity of the set of items,
collect weight information from a scale when the item is present at the scale, and
generate an item price factoring in weight information and the item identity.
